(19) United States
(12) Patent Application Publication
(10) Pub. No.: US 2017/0206675 A1
(43) Pub. Date: Jul. 20, 2017

(54) Method and Device for Providing a Virtual Sketchboard

(71) Applicant: Pixcil, Inc., San Francisco, CA (US)

(72) Inventors: Joseph Bynoe, Toronto (CA); Patrick Lyon, Walnut Creek, CA (US)

(21) Appl. No.: 15/405,989

(22) Filed: Jan. 13, 2017

Related U.S. Application Data
(60) Provisional application No. 62/278,636, filed on Jan. 14, 2016.

(51) Int. Cl. G06T 7/73; G06T 7/13; G06T 3/40; G06K 9/20; G06F 3/0354; G06T 7/174; G06K 9/00; G06T 7/246; G06T 7/60

(52) U.S. Cl. CPC G06T 7/73; G06T 7/246; G06T 7/13; G06T 3/40; G06T 7/60; G06F 3/03542; G06T 7/174; G06K 9/00409; G06K 9/2054

(57) ABSTRACT

A virtual sketchboard method and device is provided. A plurality of images of a writing utensil attachment attached to a physical writing utensil may be captured by an image capturing device, where the writing utensil attachment has a light-permeable section where light is emitted. Image analysis may be performed by the first computing device on each of the captured plurality of images and location information of the light-permeable section in each of the captured plurality of images may be determined by the first computing device based on the performed analysis. The determined location information of the light-permeable section may be transmitted by the first computing device to at least a second computing device.

### CROSS REFERENCE TO RELATED APPLICATIONS

This application claims priority to and the benefit of U.S. Provisional Application No. 62/278,636, filed Jan. 14, 2016, the contents of which are incorporated herein by reference.

### BACKGROUND ART

The invention relates to the real-time sharing of information being created by a user-participant to other user-participants of a virtual communication session.

Web conferencing technology may encompass different types of collaborative services including web seminars (“webinars”), webcasts, and peer-to-peer web meetings. Web conferencing may be implemented using Internet technologies such as TCP/IP connections. For example, a service provider may provide various web conferencing platforms to one or more users.

Web conferencing services may allow real-time communications and/or multicast communications from one sender to one or more receivers. Communications may include text-based messages as well as the sharing of voice and video data. Typically, web conferencing participants communicate with each other from geographically dispersed locations. Applications for web conferencing may include meetings, training events, lectures, seminars, and presentations from one Internet-connected computer to other Internet-connected computers.

However, the ability to effectively interface in real-time among participants of a web conference is limited. Therefore, there is a need for a virtual collaboration environment where, for instance, the expression of ideas on a writing surface from one location can be instantly and simultaneously shared and viewed at a different location.

### SUMMARY OF THE INVENTION

In accordance with one aspect of the disclosure, a plurality of images of a writing utensil attachment attached to a physical writing utensil may be captured by an image capturing device, where the writing utensil attachment has a light-permeable section where light is emitted. Image analysis may be performed by the first computing device on each of the captured plurality of images and location information of the light-permeable section in each of the captured plurality of images may be determined by the first computing device based on the performed analysis. The determined location information of the light-permeable section may be transmitted by the first computing device to at least a second computing device.

In accordance with another aspect of the disclosure, location information of light emitted from a light-permeable section of a writing utensil attachment in each of a plurality of images associated with a virtual session may be received by a first computing device from a second computing device. The location information in each of the plurality of images may be stored in memory. The location information in each of the plurality of images may be made available to at least a third computing device.

In accordance with yet another aspect of the disclosure, a device for a virtual session is provided. The device may include a physical writing utensil having a writing tip and a writing utensil attachment, which includes a light source, a light-permeable section configured to emit light from the light source, and at least one sensor configured to turn on or turn off the light source based on whether the physical writing utensil contacts a writing surface.

### BRIEF DESCRIPTION OF THE DRAWINGS

FIG. 1 illustrates an example system in which a method and device can be implemented in accordance with one or more aspects of the disclosure.

FIG. 2A illustrates an attachment in accordance with one or more aspects of the disclosure.

FIG. 2B illustrates various components of the attachment in accordance with one or more aspects of the disclosure.

FIG. 3A illustrates a flow chart in accordance with one or more aspects of the disclosure

FIG. 3B is illustrates a further flow chart in accordance with one or more aspects of the disclosure.

### DETAILED DESCRIPTION OF THE INVENTION

The invention relates to a method and device for providing a virtual sketchboard. For example, various ideas that may be sketched on a “virtual sketchboard” by a user-participant during a virtual session (e.g., meeting, conference) at one geographical location may appear approximately instantly on the “virtual sketchboard” at a second geographical location. In that regard, a “virtual sketchboard” may be shared among the user-participants—in real time—who may be located in different geographical locations as if the user-participants were in the same conference room.

In one aspect of the present disclosure, one or more users may be connected to a virtual session (meeting or conference) and a user may want to share an idea by visually drawing, sketching, writing or otherwise expressing the idea on a writing surface. For example, a computing device, such as a smartphone, laptop, tablet computer, desktop computer, etc., may capture numerous images of the physical writing utensil (such as a marker) and a writing utensil attachment that may be attached or coupled to the marker, via one or more cameras, while the user writes on the writing surface. The computing device may then process and/or analyze the captured images to determine various data points associated with the motion and movement of the marker, and to derive handwriting/sketch information to send to one or more backend servers, such as a remote server computer and/or other type of computing and storage devices. The one or more backend servers may allow the multiple users to write to, or read from, the particular session as “contributors,” while storing the data points and handwriting/sketch information for simultaneous or later use. The multiple users may connect to the one or more backend servers using an interface, such as a web browser, to view in real-time what is being sketched or written. As such, the one or more backend servers, which are configured to receive and store data and allow users to access in real-time the data associated with the virtual session. Other users may take turns and also write, draw, sketch, etc. on the same virtual sketchboard.

The writing utensil attachment, for example, may include an illuminated section that may be used by the computing device to track the location and/or movement of the physical writing utensil as the user is writing or sketching. The computing device, via software for instance, may track and record the user's sketch/writing in real-time and transcribe such to a virtual sketchboard, which may be viewed and/or contributed to by users who are given permission to view and/or edit content on the virtual sketchboard.

The writing surface may be any traditional writing surface, such as paper, a whiteboard, chalkboard, etc., or can be any surface since, for example, the one or more cameras capture and/or track the motion of the physical writing utensil irrespective of the surface on which it is being used. Therefore, the virtual sketchboard of the present disclosure does not necessarily require a “special” or customized type of writing surface, such as an electronic board or the like.

As will be further discussed below, the present disclosure provides numerous advantages. For example, the virtual sketchboard may increase productivity among meeting participants and the encouragement of collaboration. Moreover, the writing utensil attachment may at least minimize cost, the user's learning curve, and also mobilize the use of the virtual sketchboard.

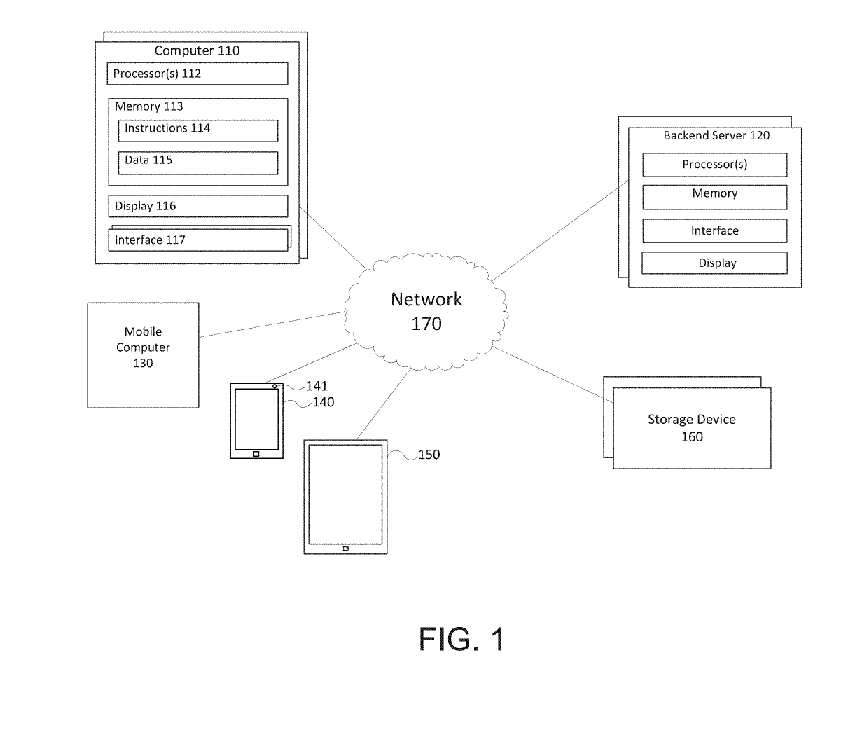

FIG. 1 illustrates an example system in which a method and device can be implemented in accordance with one or more aspects of the disclosure. The system may include a plurality of computers and/or computing devices, such as, computer 110, backend server 120, mobile computer 130, smartphone 140, tablet computer 150, and storage device 160, all connected to network 170. By way of example only, computer 110 may include various components associated with a computer, such as one or more processors 112, memory 113 (which includes instructions 114 and data 115), display 116, and an interface 117. Similarly, backend server 120 may also include one or more processors, memory, interface, and/or display and may be configured to communicate with at least one of computer 110, mobile computer 130, smartphone 140, tablet computer 150 and storage device 150. In another example, the mobile computer 130 may be a laptop or Ultrabook (or any computing device that is mobile) and also include components similar to the computer 110 and backend server 120. As illustrated by the cascaded blocks, there may be more than one of each device connected to the network 170. For example, there may be more than one computer and/or backend server connected to the network.

The processor 112 of computer 110 may instruct the components of computer 110 to perform certain tasks based on the processing of information, such as instructions 114 and/or data 115 that may be stored in memory 113. The processor 112 may be a standard processor, such as a central processing unit (CPU), or may be a dedicated processor, such as an application-specific integrated circuit (ASIC) or a field programmable gate array (FPGA). By way of example only, at least one control unit (not shown) coupled to an arithmetic logic unit (ALU) (not shown) and memory 113 may direct the computer 110 to carry out program instructions 114 stored in memory 113. While one processor block is shown in FIG. 1 to depict the processor 112, the computer 110 may also include multiple processors that may be connected in various configurations.

Memory 113 stores information that can be accessed by processor 112 including instructions 114 executable by the processor 112. Data 115 can be retrieved, manipulated or stored by the processor 112. For example, memory 113 may be hardware capable of storing information accessible by the processor, such as a ROM, RAM, hard-drive, CD-ROM, DVD, write-capable, read-only, etc.

The instructions 114 may include a set of instructions to be executed directly (e.g., machine code) or indirectly (e.g., scripts) by the processor 112. The set of instructions may be included in software that can be implemented on the computer 110. It should be noted that the terms “instructions,” “steps,” “algorithm,” and “programs” may be used interchangeably. As will be further discussed below, the instructions 114, for example, may include at least a set of executable instructions to process and/or analyze a plurality of images of a physical writing utensil and the corresponding attachment captured by a camera of computer 110 (e.g., image analysis, movement analysis, location analysis, etc.) and to send the information (including the data points) to backend server 120 and/or storage device 160 via the network 170. The set of executable instructions included in the instructions 114 may originate from memory 114 (because it may have been originally stored thereon) or may be first downloaded (e.g., an application) from a different computing device connected to network 170 (e.g., backend server 120, mobile computer 130, smartphone 140, tablet computer 150, storage device 160) and then stored in memory 113.

The data 115 may be retrieved, stored, modified, and/or manipulated by the processor 112 in accordance with the set of instructions 114 or other sets of executable instructions stored in memory. The data 115 may be stored as a collection of data. The disclosure is not limited by any particular data structure and the data 115 may be stored in computer registers, in a database as a table having a plurality of different fields and records, such as an XML. The data 115 may also be formatted in any computer readable format such as, binary values, ASCII, EBCDIC (Extended Binary-Coded Decimal Interchange Code), etc. As an example, the data 115 may include the plurality of images of the physical writing utensil and the corresponding attachment captured via the camera of computer 110, as well as the data points corresponding to the movement of the physical writing utensil (e.g., handwriting) and other data derived from the processing and/or analysis of the captured plurality of images. As a further example, the data 115 may be received by the backend server 120 from one or more users using computer 110, the mobile computer 130, smartphone 140 and/or the tablet computer 150, and stored in storage device 160.

The display 116 may be any type of device capable of communicating data to a user, such as a liquid-crystal display (“LCD”) screen, a plasma screen, etc. Interface 117 may be a device, port, or a connection that allows a user to communicate with the computer 110, such as a keyboard, a mouse, touch-sensitive screen, microphone, camera, etc., and may also include one or more input/output ports, such as a universal serial bus (USB) drive, CD/DVD drive, zip drive, various card readers, etc.

The backend server 120 may be rack mounted on a network equipment rack and/or located in a data center. In one aspect, the backend server 120 may use the network 170 to serve the requests of programs executed on computer 110, mobile computer 130, smartphone 140, tablet computer 150, and/or storage device 160. For example, the backend server 120 may allow certain computing devices connected to network 170 to access the data 115 (either stored in backed server computer 120 or storage device 160) associated with a particular session or web conference/meeting in order to at least facilitate real-time collaboration among the participants.

Mobile computing devices, such as the mobile computer 130, smartphone 140, and tablet computer 150, may also have similar components and/or functions to the computer 110 and backed server 120, such as a processor, memory, instructions, data, input/output capabilities, display, interfaces, etc.

For example, the mobile computer 130 may be any type of mobile device with computing capability and/or connectivity to a network, such as a laptop, Ultrabook, smartphone, PDA, tablet computer, etc. The mobile computer 130 may be able to connect to network 170 using a wired connection or a wireless connection to communicate with the other various devices of the network 170.

In another example, the smartphone 140 may include all the components typically present on a cellular telephone and computer, including camera 141, one or more processors, memory, communication chipsets, antenna, touchscreen display, microphone, buttons, sensors, speakers, etc. Like computer 110 and backend server 120, the smartphone 140 may also execute programmable instructions via the one or more processors and instructions and data stored in memory, as well as connect to the network 170 via wired and/or wireless connections. As will be further discussed below, the camera 141 of the smartphone 140, for instance, may capture a plurality of images of the writing utensil attachment so as to perform analysis and processing on the captured images and to acquire data points associated with the movement of the physical writing utensil. In that regard, the smartphone 140 may be configured to transcribe the user's handwriting and send the handwriting information across the network 170 to the backend server 120 and/or storage device 160.

Moreover, tablet computer 150 may also include all of the components typically present in/on a tablet computer including a touchscreen display, sensors, microphone, camera, speakers, etc. (not shown), and may execute computer instructions, applications, or programs using at least one of one or more processors, memory, and other processing hardware contained therein. Similar to the mobile computer 130 and smartphone 140, the tablet computer 150 may also be configured to connect to network 170 via wired and/or wireless connections.

The storage device 160 illustrated in FIG. 1 may be configured to store a large quantity of data. For example, the storage device 160 may be a collection of storage components, or a mixed collection of storage components, such as ROM, RAM, hard-drives, solid-state drives, removable drives, network storage, virtual memory, cache, registers, etc. The storage device 160 may also be configured so that the backend server 120 can access it via the network 170, or so that computer 110, mobile computer 130, smartphone 140, and/or tablet computer 150 can either directly or indirectly access it. By way of example only, the storage device 160 may store the above-described plurality of images of the physical writing utensil and the corresponding attachment captured via one or more cameras, as well as the data points corresponding to the movement of the physical writing utensil (e.g., handwriting) and other data derived from the processing and/or analysis of the captured plurality of images associated with a particular session, meeting, or conference.

The network 170 may be any type of network, wired or wireless, configured to facilitate the communication and transmission of data, instructions, etc. from one component to another component of the network. For example, the network 170 may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

Although the processor 112, memory 113, display 116 and interface 117 are functionally illustrated in FIG. 1 in the same blocks, it will be understood that they may include multiple processors, memories, displays or interfaces that may not be stored within the same physical housing. Moreover, the system and operations described herein and illustrated in FIG. 1 will now be described below, and the operations are not required to be performed in a particular or precise order. Rather, the operations may be performed in a different order, different combinations, or simultaneously, etc.

Various aspects and examples associated with the virtual sketchboard are described below.

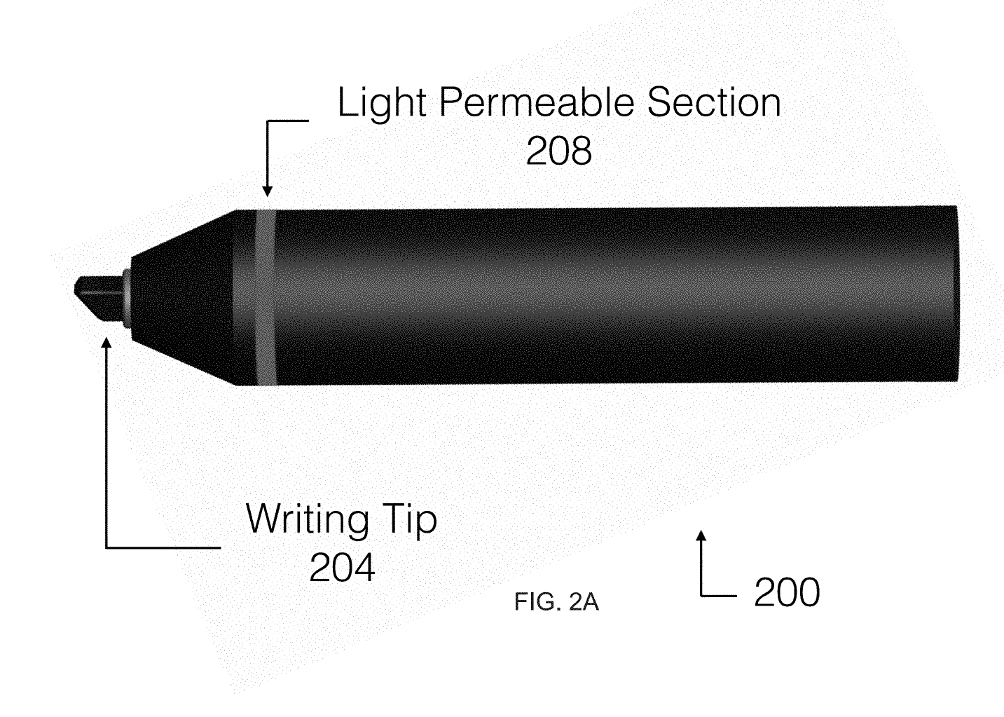

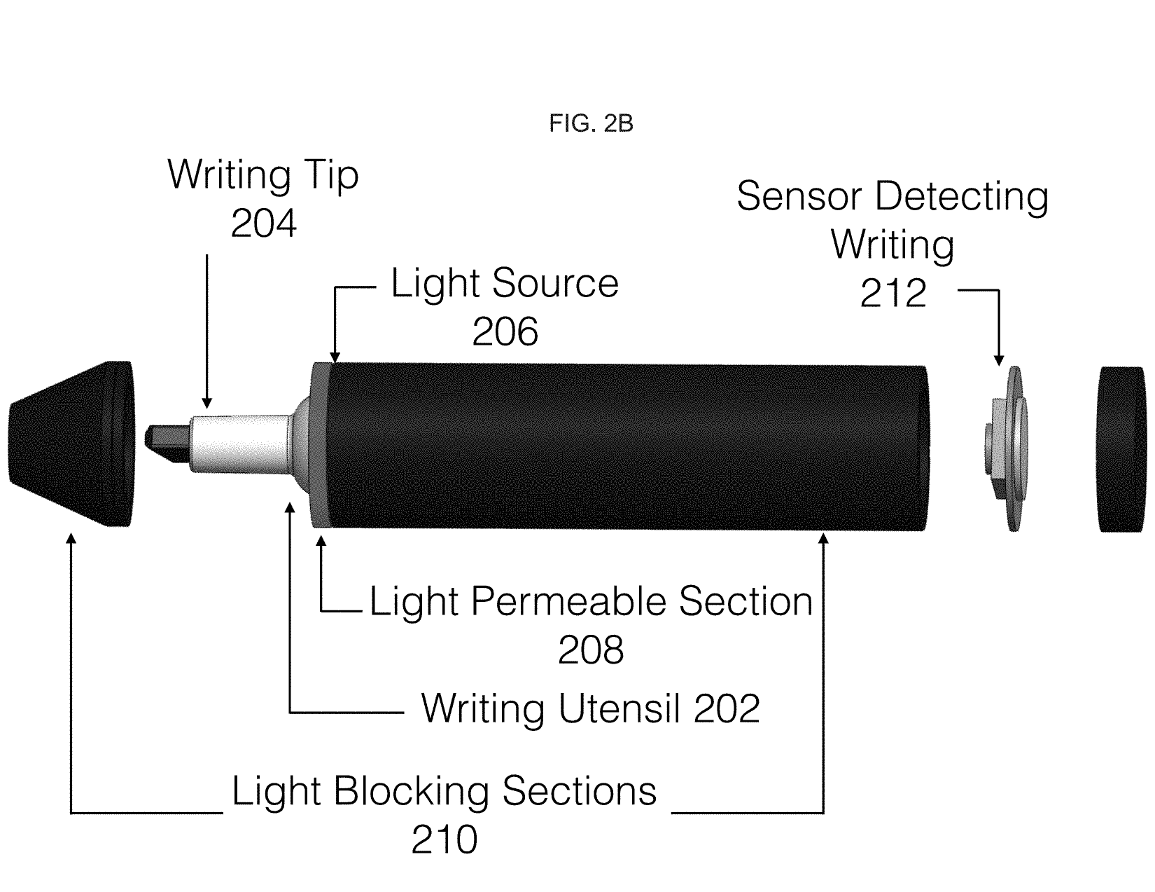

As described above, a writing utensil attachment may be coupled to, or arranged on, a physical writing utensil in order to allow a computing device, via a camera, to acquire data points associated with the movement/motion of the physical writing utensil based on image analysis and/or processing of a plurality of captured images of the attachment. FIGS. 2A and 2B illustrate the attachment in accordance with one or more aspects of the disclosure and the various components thereof.

FIG. 2A illustrates an attachment 200 that is fully coupled to (or arranged on) a physical writing utensil. By way of example, the casing of the attachment 200 may be cylindrical in shape such that it encloses a majority of the physical writing utensil. As shown, however, the writing tip 204 of the physical writing utensil is exposed at one end of the attachment 200. During operation, a light-permeable section 208 may emit light from a light source of the attachment 200. The illuminated section, for instance, may be used to track the location of the physical writing utensil when a user is writing, sketching, and/or drawing with the physical writing utensil. In another example, when the user is not writing, the light source may turn off and the light-permeable section 208 may no longer be emitting any light. Although FIG. 2A illustrates the attachment 200 having a cylindrical shape, it is understood that the attachment 200 may be any conceivable shape, including but not limited to a rectangular shape, hexagonal shape, trapezoidal shape, or any shape which corresponds with the overall shape of the physical writing utensil.

FIG. 2B illustrates an exploded view of the attachment 200 in relation to the physical writing utensil 202. For example, FIG. 2B shows the physical writing utensil 202 with the writing tip 204 (which is also shown in FIG. 2A). Although not limited to a particular type of writing utensil, the physical writing utensil 202 in the example of FIG. 2B may be a dry erase marker with the writing tip 204 being the marker tip. A light source 206 (not shown) may be arranged on one end of the attachment 200 and covered by the light-permeable section 208. For example, the light source 206 may be configured on an end adjacent to the writing tip 204 of the physical writing utensil 202. The light source 206 may include one or more light emitting diodes (LEDs) to illuminate the light-permeable section 208. Light blocking sections 210 may be arranged adjacent to the light-permeable section 208 in order to block light being emitted from the light source that would otherwise be visible on the attachment 200. Moreover, a sensor 212 may be configured at an opposite end from the light source 206 and is configured to detect when the physical writing utensil, or the dry erase in this example, is in contact with a dry erase board so as to turn on or off the light source 206. A battery (not shown) may be arranged on the back of the sensor 212.

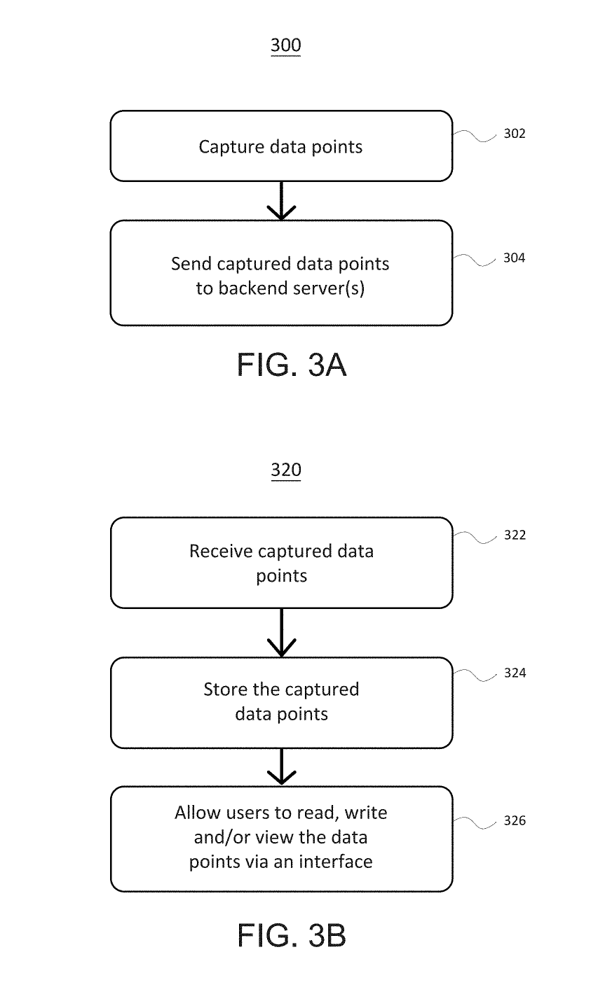

The real-time sharing of ideas, sketches, drawings, or writings on a virtual sketchboard among the participant-users of a virtual session may involve different aspects of a network. On one end of the network, for instance, a computing device (such as the smartphone 140 of network 170 in FIG. 1) may process and send numerous data points associated with the movement of the light-permeable section 208 of the attachment 200 to backend server 120 and/or the storage devices 160 of network 170 in FIG. 1. On a different end of the network, for example, the backend server 120, for example, may receive the data points and transform the data in order to allow the other participant-users to read, write, and/or view the data (e.g., idea, sketch, drawing, writing, etc.) on the virtual sketchboard. FIGS. 3A and 3B illustrate different flow charts associated with the aforementioned aspects of the present disclosure.

FIG. 3A illustrates a flow chart 300 including at least the acts of capturing data points (e.g., block 302) and sending the data points (e.g., block 304) to one or more backend server of a network.

At block 302, a computing device, via a camera, may continuously capture numerous images of light being emitted from a writing utensil attachment while a user is sketching, writing, drawing, etc. with a physical writing utensil on a writing surface. The computing device may then process and analyze each image to determine the location of the physical writing utensil within the image. Collectively, the locations of the physical writing utensil in the images may produce movement/motion data that can be sent to the backend server(s) described below, which may be shown to other users in real-time.

Using the examples illustrated in FIGS. 1, 2A and 2B, for example, a user may initiate sketchboard software on the user's smartphone 140 in order to join a virtual session and to draw on a virtual sketchboard for other participants of the virtual session to view in real time. The user attaches attachment 200 on a physical writing utensil and applies the writing tip 204 of the physical writing utensil 202, for instance, to a writing surface, which turns on the light source 206 of the attachment 200. The light being emitted from light source 206 is visible via the light-permeable section 208. The camera 141 of smartphone 140 may then capture continuous images (e.g., 1280×720 images) of the physical writing utensil 202, the attachment 200, as well as the light from the light-permeable section 208. The smartphone 140 may be configured to capture numerous frames per second (e.g., 120 frames per second, 240 frames per second). The smartphone 140 may then process one or more of the captured images by calculating the width of the light segment produced by the light-permeable section 208 and finding the center of the light segment associated with the attachment 200.

By way of example only, to calculate the width of the light segment, the smartphone 140 first takes an image and removes all the colors that are not contained within a predefined spectrum around the color of the light source 206. As such, this may leave just the light source in the image and also account for certain external lighting conditions. An edge detector, via a Sobel filter and/or Canny Edge Detection, may then be used to find the edges of the light segment. Then, the smartphone 140 determines the contours of those edges and fits a rotated bounded box to the largest contour. In this regard, the dimensions of the box may be the dimensions of the light segment.

In view of the configuration of the light-permeable section 208 of attachment 200, the width may be larger than the height, so the smartphone 140 may take the larger of the two dimensions (e.g., height, width) and assign the larger dimension as the width. It is understood that it is possible to do so with any dimension of the bounded box. The smartphone 140 may then scale the values associated with the dimensions so that it may translate into a distance away from the camera 141. The scaling function, for example, may include a reciprocal component and a constant gain. The new value calculated from the width may be considered the x-coordinate when being displayed on a screen.

By way of another example, to calculate the center of the light segment, the smartphone 140 may find the horizontal center of the bounded box relative to the horizontal center of the image. The smartphone 140 may then scale the center value by taking the distance from the center of the image and the height of the light segment and algorithmically create a new value. The height of the light may be included to account for discrepancies that occur as the user and the physical writing utensil moves further from the camera. The new value may correspond to the Y coordinate when displaying on a screen.

The above calculations may be performed and repeated for every frame captured by the camera 141. This may provide snapshots of the location of the physical writing utensil at fractions of a second, which allows fast movement and motion of the user's sketching, drawing, writing, etc. to be captured.

At block 304, the captured data, such as one or more of the frames, images, calculations of the width of the light segment, and determinations of the center of the light segment, is sent to one or more backend servers of network 170, such as backend server 120 and storage devices 160.

FIG. 3B illustrates a flow chart 320 including at least the acts of the one or more backend servers receiving the captured data points (e.g., block 322), storing the data points (e.g., block 324), and allowing the connected users to read, write, and/or view the data via an interface (e.g., block 326).

At block 322, the one or more backend servers receive the data described with respect to blocks 302 and 304 in FIG. 3A, for instance. The backend servers may store the data at block 324 for later use, if necessary. The storing of the data may immediate upon receipt or delayed. The backend servers may determine and associate the received data with the corresponding virtual session. Moreover, at block 326, the backend servers are configured to translate the data to viewable information and allow the various participant-users of the virtual session to read, write, and/or view the data via respective interfaces.

For instance, the interface may be a web browser that is able to connect to the backend servers via network 170. By way of example, the web browsers may be implemented using computer 110, mobile computer 130, and tablet computer 150 of network 170. As such, the data being transmitted to the one or more backend servers can be viewed in real-time by the other participants as if they were in the same conference room as the user who is transcribing the data on the writing surface. In that regard, the functionalities associated with the one or more backend servers may be considered the “virtual” sketchboard.

Although the flow charts of FIGS. 3A and 3B are illustrated separately, it can be understood that the features of the blocks illustrated therein can be performed simultaneously. Moreover, the transmission and reception of data by the various network components of a network can be performed in any order and is not limited to a particular order or sequence.

The numerous advantages of the present disclosure include, for example, the ability to attach an inexpensive attachment to an already existing writing utensil, which allows a computer such as a smartphone to track and record a user's writing in real-time. Moreover, a specialized writing surface is not required to implement the various aspects of the present disclosure. Therefore, the computer may transcribe, for instance, the user's handwriting to one or more backend servers to create a virtual sketchboard where the user's sketches appear instantly (or almost instantly) and where the sketchboard may be viewed, or contributed to, by users who are given access to the virtual session (meeting or conference).

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

The term “backend server” means a functionally-related group of electrical components, such as a computer system in a networked environment which may include both hardware and software components, or alternatively only the software components that, when executed, carry out certain functions. The “backend server” may be further integrated with a database management system and one or more associated databases.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof. Although the disclosure use terminology and acronyms that may not be familiar to the layperson, those skilled in the art will be familiar with the terminology and acronyms used herein.

What is claimed is:

1. A method for capturing and analyzing movement of a physical writing utensil during a virtual session, the method comprising the acts of:
capturing, by an image capturing device, a plurality of images of a writing utensil attachment attached to a physical writing utensil, wherein the writing utensil attachment has a light-permeable section where light is emitted;
performing image analysis, by a first computing device, on each of the captured plurality of images;
determining, by the first computing device based on the performed image analysis, location information of the light-permeable section of the writing utensil attachment in each of the captured plurality of images, wherein the location information is based on light emitted from the light-permeable section; and
transmitting, by the first computing device, the determined location information of the light-permeable section for each of the captured plurality of images to at least a second computing device.

2. The method of claim 1, wherein the location information of the light-permeable section for each of the captured plurality of images collectively produces movement data corresponding to the movement of the writing utensil.

3. The method of claim 1, wherein capturing the plurality of images further comprises capturing at least 120 images of the writing utensil per second.

4. The method of claim 1, wherein performing image analysis on each of the captured plurality of images further comprises removing all colors from the captured plurality of images that are not contained within a predefined spectrum associated with a color of the light emitted from the light-permeable section.

5. The method of claim 1, wherein performing analysis on each of the captured plurality of images further comprises detecting, within the captured plurality of images, one or more edges of the light emitted from the light-permeable section using at least one edge detection technique.

6. The method of claim 5, wherein the at least one edge detection technique includes using a Sobel filter and Canny Edge detection.

7. The method of claim 5, wherein performing analysis on each of the captured plurality of images further comprises:
determining at least one contour based on the one or more edges of the light emitted from the light-permeable section; and
fitting a virtual box around a largest contour from the determined at least one contour.

8. The method of claim 7, wherein dimensions of the virtual box corresponds to dimensions of the light from the light-permeable section of the writing utensil attachment.

9. The method of claim 1, wherein determining the location information of the light-permeable section further comprises determining a width dimension value and a height dimension value of the light from the light-permeable section of the writing utensil attachment.

10. The method of claim 9, wherein determining the location information of the light-permeable section further comprises scaling the width dimension value and the height dimension value based on a scaling function so as to account for distance of the writing utensil attachment relative to the image capturing device.

11. The method of claim 9, wherein the scaling function includes one or more of: (i) a reciprocal component and (ii) a constant gain.

12. The method of claim 9, wherein determining the location information of the light-permeable section further comprises:
calculating a center value of the light emitted from the light-permeable section by determining a horizontal center of the light relative to a horizontal center of the captured image; and
scaling the center value so as to account for discrepancy due to the writing utensil attachment moving further from the at least one image capturing device.

13. A method for receiving movement data of a physical writing utensil during a virtual session, the method comprising the acts of:
receiving, by a first computing device, location information of light emitted from a light-permeable section of a writing utensil attachment in each of a plurality of images associated with the virtual session from a second computing device;
storing, by the first computing device, the location information in each of the plurality of images in memory; and
making available, by the first computing device, the location information in each of the plurality of images to at least a third computing device.

14. The method of claim 13, wherein the location information in each of the plurality of images is stored in the memory immediately upon receiving the location information from at least the first computing device or delayed for a predetermined period of time.

15. The method of claim 13, further comprising the acts of:
determining, by the first computing device, that the received location information in each of the plurality of images is associated with the virtual session; and
associating, by the first computing device, the received location information in each of the plurality of images with the virtual session.

16. A device for a virtual session, the device comprising:
a physical writing utensil having a writing tip;
a writing utensil attachment including:
a light source,
a light-permeable section configured to emit light from the light source, and
at least one sensor configured to turn on or turn off the light source based on whether the physical writing utensil contacts a writing surface.

17. The device of claim 16, further comprising one or more light blocking sections arranged adjacent to the light-permeable section so as to block the light that would otherwise be visible on the writing utensil attachment.

18. The device of claim 16, wherein the light source includes one or more light emitting diodes.

19. The device of claim 16, wherein the light source is arranged adjacent to the writing tip of the physical writing utensil.

20. The device of claim 16, wherein the sensor is arranged at an end opposite from where the light source is arranged.
